(19) United States
(12) Patent Application Publication
(10) Pub. No.: US 2026/0237728 A1
(43) Pub. Date: Aug. 13, 2026

(54) Secondary Battery

(71) Applicant: LG Energy Solution, Ltd., Seoul (KR)

(72) Inventor: Jin Uk Do, Daejeon (KR)

(73) Assignee: LG Energy Solution, Ltd., Seoul (KR)

(21) Appl. No.: 19/538,210

(22) Filed: Feb. 12, 2026

(30) Foreign Application Priority Data
Feb. 12, 2025 (KR) 10-2025-0018128
Feb. 10, 2026 (KR) 10-2026-0026919

(51) Int. Cl. H01M 10/0525; H01M 10/052; H01M 50/103; H01M 50/342; H01M 50/55

(52) U.S. Cl. CPC H01M 10/0525; H01M 10/052; H01M 50/103; H01M 50/3425; H01M 50/55; H01M 2220/20

(57) ABSTRACT

A secondary battery according to an aspect of the present disclosure includes a case, an electrode assembly accommodated inside the case, a vent hole formed in a lower surface of the case, a spacing member protruding from the lower surface to space the electrode assembly apart from the vent hole, a venting flow path disposed on a side of the spacing member on the lower surface, and a cap assembly sealing the case. Gas inside the case is guided by the spacing member along the venting flow path and discharged to the outside through the vent hole.

### CROSS REFERENCE TO RELATED APPLICATIONS

This application is based on and claims priority from Korean Patent Application No. 10-2025-0018128, filed on February 12, 2025 and Korean Patent Application No. 10-2026-0026919 filed on February 10, 2026, with the Korean Intellectual Property Office, the disclosures of which are incorporated herein in their entireties by reference.

### TECHNICAL FIELD

The present disclosure relates to a secondary battery.

### BACKGROUND

As the demand for portable electronic products such as notebook computers, video cameras, and mobile phones has dramatically increased recently, and the development of electric vehicles, energy storage batteries, robots, and satellites is actively being pursued, research on high-performance secondary batteries capable of repeated charging and discharging is being actively conducted.

Among these, lithium secondary batteries mainly uses a lithium-based oxide as a positive electrode active material and a carbon-based material as a negative electrode active material. In addition, lithium secondary batteries include a positive electrode plate and a negative electrode plate on which the positive electrode active material and the negative electrode active material are respectively applied, an electrode assembly in which the positive electrode plate and the negative electrode plate are disposed with a separator interposed therebetween, and an outer casing configured to hermetically accommodate the electrode assembly together with an electrolyte.

Meanwhile, lithium secondary batteries may be classified, according to the shape of the battery case, into a can-type secondary battery in which the electrode assembly is accommodated in a metal can, and a pouch-type secondary battery in which the electrode assembly is accommodated in a pouch formed of an aluminum laminate sheet. Further, the can-type secondary battery may be classified, according to the shape of the metal can, into a cylindrical battery and a prismatic battery.

As the range of applications of such secondary batteries expands, efforts to improve the performance of secondary batteries are being steadily pursued along with the efforts to enhance their safety.

### SUMMARY

The present disclosure provides a secondary battery in which gas inside a case is rapidly discharged, thereby preventing or suppressing the risk of an explosion and improving safety.

According to an aspect of the present disclosure, a secondary battery includes a case, an electrode assembly accommodated inside the case, a vent hole formed in a lower surface of the case, a spacing member protruding from the lower surface to space the electrode assembly apart from the vent hole, a venting flow path disposed on a side of the spacing member on the lower surface, and a cap assembly sealing the case. The gas inside the case is guided by the spacing member along the venting flow path and discharged to an outside through the vent hole.

The spacing member may be integrally formed with the case.

The spacing member may extend along a length direction of the lower surface.

A plurality of the spacing members may be provided to be spaced apart from each other.

The plurality of the spacing members may be spaced apart from each other along the length direction.

The plurality of the spacing members may be positioned in the same row.

The vent hole may be positioned between the plurality of the spacing members.

The plurality of the spacing members may form a plurality of rows spaced apart from each other in a width direction.

The plurality of the spacing members may be arranged in an X-shape.

The spacing member may extend from one end to the other end of the lower surface in the length direction.

The spacing member may be positioned at the center of the lower surface in a width direction.

A plurality of the vent holes may be formed.

A plurality of the spacing members may be formed, and the plurality of the spacing members may be positioned at opposite ends of the lower surface in a width direction.

The spacing member may be formed of the same material as the case.

The case and the spacing members may be manufactured by an extrusion method.

A plurality of the spacing members may be formed, and the plurality of the spacing members may form a plurality of rows extending from one end to the other end of the lower surface.

The plurality of the spacing members may form three rows arranged parallel to each other.

The plurality of the spacing members may form five rows arranged parallel to each other.

The vent hole may be positioned between an adjacent pair of rows.

The vent hole may overlap with at least one of the plurality of the spacing members in a height direction.

According to an aspect of the present disclosure, gas inside the case may be rapidly discharged, thereby preventing or suppressing the risk of an explosion of the secondary battery and improving safety.

### BRIEF DESCRIPTION OF THE DRAWINGS

The drawings attached herewith are merely illustrative of embodiments of the present disclosure, and take on the role of further facilitating the understanding of the technical idea of the present disclosure along with the descriptions herein. Thus, the present disclosure should not be construed as being limited to those illustrated in the drawings.

FIG. 1 is a perspective view illustrating a secondary battery, according to a first embodiment of the present disclosure.

FIG. 2 is a perspective view illustrating a state in which some components of the secondary battery of FIG. 1 are exploded.

FIG. 3 is a projection perspective view illustrating an interior of a case of the secondary battery.

FIG. 4 is a vertical cross-sectional side view illustrating the case of FIG. 3, in which an electrode assembly is accommodated, as viewed in a length direction.

FIG. 5 is a cross-sectional view illustrating the case of FIG. 3, in which the electrode assembly is accommodated, taken along line A-A.

FIG. 6 is a horizontal cross-sectional view illustrating a lower surface of a case of a secondary battery, according to a second embodiment of the present disclosure.

FIG. 7 is a vertical cross-sectional side view illustrating the case of FIG. 6.

FIG. 8 is a view illustrating a modified example of the case of FIG. 6.

FIG. 9 is a view illustrating a modified example of the case of FIG. 6.

FIG. 10 is a horizontal cross-sectional view illustrating a lower surface of a case of a secondary battery, according to a third embodiment of the present disclosure.

FIG. 11 illustrates a modified example of the case of FIG. 10.

FIG. 12 is a horizontal cross-sectional view illustrating a lower surface of a case of a secondary battery, according to a fourth embodiment of the present disclosure.

FIG. 13 is a view illustrating a modified example of the case of FIG. 12.

FIG. 14 is a horizontal cross-sectional view illustrating a lower surface of a case of a secondary battery, according to a fifth embodiment of the present disclosure.

FIG. 15 is a vertical cross-sectional side view illustrating the case of FIG. 14.

FIG. 16 is a view illustrating a modified example of the secondary battery of FIG. 1.

FIG. 17 is a horizontal cross-sectional view illustrating a lower surface of a case of a secondary battery, according to a sixth embodiment of the present disclosure.

FIG. 18 is a view illustrating a modified example of the case of FIG. 17.

FIG. 19 is a view illustrating a modified example of the case of FIG. 17.

Corresponding reference characters indicate corresponding components throughout the several views of the drawings, but different reference characters may be given as necessary. The drawing figures presented are illustrated for simplicity and clarity and have not necessarily been drawn to scale. For example, the dimensions of some of the elements in the figures may be exaggerated relative to other elements to help to improve understanding of various embodiments. Also, common but well-understood elements that are useful or necessary in a commercially feasible embodiment are often not depicted in order to facilitate a less obstructed view of these various embodiments.

### DETAILED DESCRIPTION

The present disclosure may be modified in various ways and may have various embodiments, and specific embodiments will be illustrated and described in detail in the detailed description. However, this is not intended to limit the present disclosure to specific embodiments, and it should be understood that the present disclosure includes all modifications, equivalents, and substitutes falling within the spirit and technical scope of the present disclosure.

The terms used in the present disclosure are used only for the purpose of describing particular embodiments and are not intended to limit the present disclosure. As used herein, singular forms include plural forms unless the context clearly indicates otherwise. In the present disclosure, it should be understood that the terms such as "include" and "have" are intended to specify the presence of stated features, numbers, steps, operations, elements, components, or combinations thereof described in the specification, but do not preclude the presence or addition of one or more other features, numbers, steps, operations, elements, components, or combinations thereof.

Hereinafter, embodiments of the present disclosure will be described in detail with reference to the accompanying drawings. At this time, it is to be noted that the same reference numerals are used to denote the same components in the accompanying drawings wherever possible. In addition, detailed descriptions of well-known functions and configurations that may obscure the gist of the present disclosure will be omitted. For the same reason, some components in the accompanying drawings are illustrated in an exaggerated, omitted, or schematic manner.

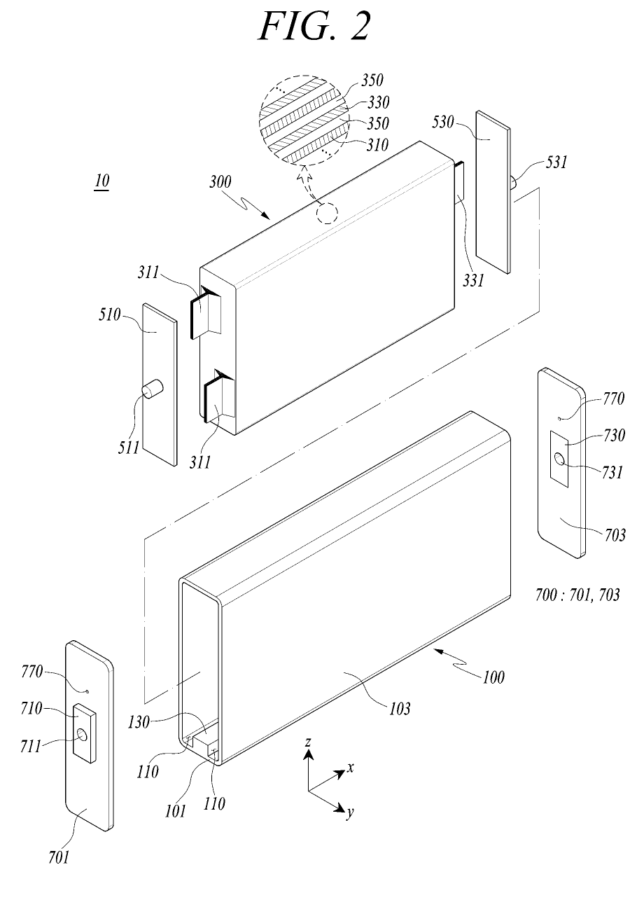

As used herein, the term “length direction” refers to the x-direction of the coordinate axes illustrated in FIG. 2, the term “width direction” refers to the y-direction, and the term “height direction” refers to the z-direction.

In the case of a secondary battery, a vent hole may be formed to prevent or suppress an explosion when internal pressure increases. However, since an electrode assembly is accommodated inside the case, the gas inside the case is blocked by the electrode assembly, making it difficult for the gas to be rapidly discharged through the vent hole. Accordingly, the risk of explosion of the secondary battery increases, resulting in a reduced safety.

In consideration of these points, the present disclosure provides a secondary battery case that allows the gas inside the case to be rapidly discharged, preventing or suppressing the explosion risk and enhancing safety, and a secondary battery using the same.

Hereinafter, a secondary battery, according to a first embodiment of the present disclosure, will be described.

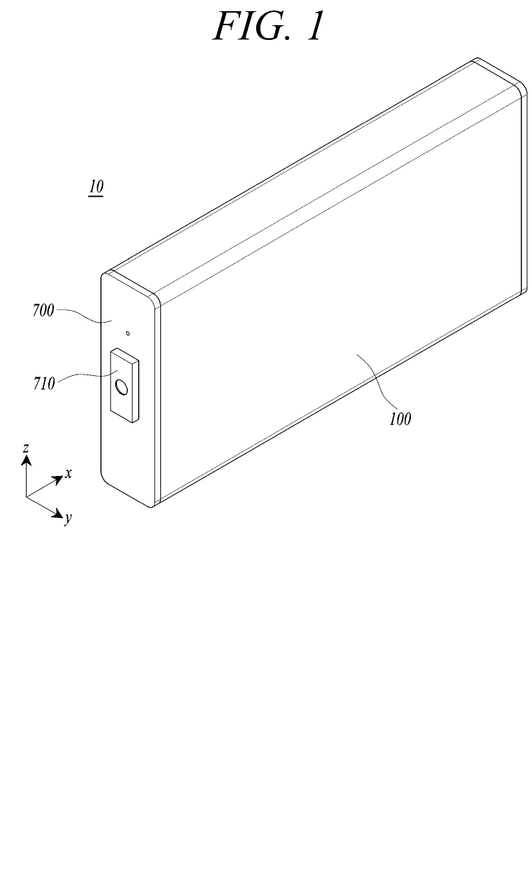

FIG. 1 is a perspective view illustrating a secondary battery, according to a first embodiment of the present disclosure, and FIG. 2 is a perspective view illustrating a state in which some components of the secondary battery of FIG. 1 are exploded.

Referring to FIGS. 1 and 2, a secondary battery 10, according to the first embodiment of the present disclosure, includes a case 100, an electrode assembly 300 accommodated inside the case 100, current-collecting plates 510 and 530 connected to the electrode assembly 300, and a cap assembly 700 (701, 703) configured to seal the case 100.

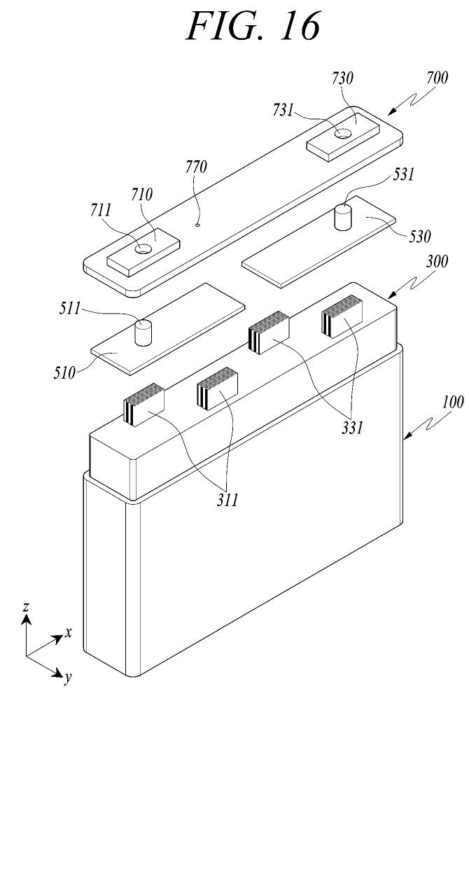

The case 100 forms an external appearance of the secondary battery 10, and has a space formed therein to accommodate the electrode assembly 300, and openings may be formed on opposite side surfaces thereof in a length direction (e.g., the x direction). However, the case 100 is not limited to a shape having openings formed in opposite directions, and may have a shape in which at least one surface other than a lower surface 101 is open (see, e.g., FIG. 16).

The case 100 may have a rectangular parallelepiped shape, and may be formed of a durable material capable of protecting the electrode assembly 300 accommodated therein. For example, the case 100 may be made of a metal such as aluminum or stainless steel.

An electrolyte may be accommodated in the case 100 together with the electrode assembly 300. The electrolyte may include a lithium salt such as LiPF₆ or LiBF₄ dissolved in an organic solvent such as EC, PC, DEC, EMC, or DMC. The electrolyte may be in a liquid, solid, or gel state.

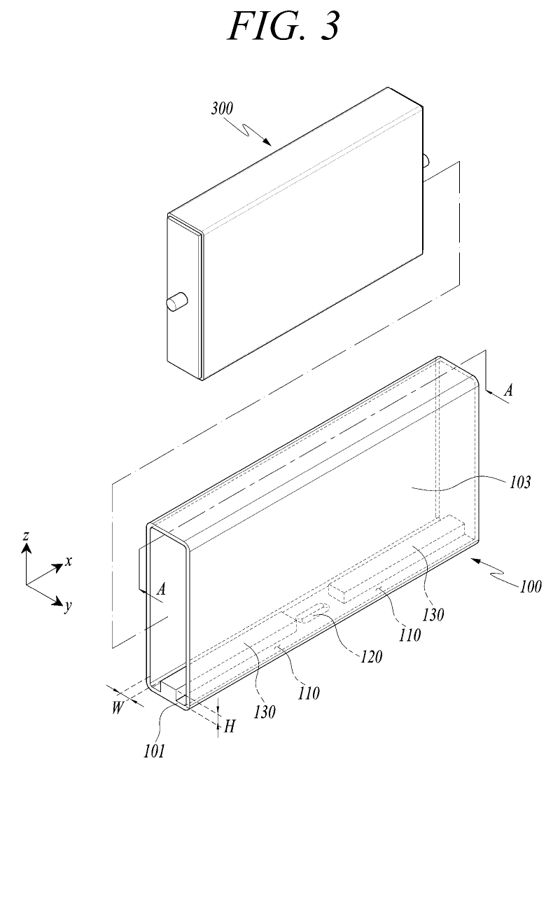

The electrode assembly 300 is accommodated inside the case 100. A spacing member 130 protrudes from a lower surface 101 of the case 100. The electrode assembly 300 is disposed to be spaced apart from the lower surface 101 of the case 100 by the spacing member 130. Since a vent hole 120 is formed in the lower surface 101 (see, e.g., FIG. 3), the electrode assembly 300 may be spaced apart from the vent hole 120. A detailed structure of the case 100 other than those described above will be described later.

The electrode assembly 300 may be formed such that a separator 350 is interposed between a first electrode 310 and a second electrode 330 that are alternately disposed. For example, the separator 350 may be disposed between the first electrode 310 and the second electrode 330 such that the electrode assembly 300 is formed by alternately stacking the first electrode 310, the separator 350, the second electrode 330, and the separator 350 in that order. Here, the first electrode 310 and the second electrode 330 may be a positive electrode and a negative electrode, respectively, or conversely, the first electrode 310 and the second electrode 330 may be a negative electrode and a positive electrode, respectively, having different polarities.

In this embodiment, the electrode assembly 300 may be formed by winding the first electrode 310 and the second electrode 330 (e.g., a wound type), or may be formed by stacking the first electrode 310 and the second electrode 330 to overlap each other in parallel (e.g., a stack type).

The first electrode 310 and the second electrode 330 of the electrode assembly 300 may each include an electrode active portion, which is a region in which an active material is applied to a thin plate formed of a metal foil, and an electrode tab 311 or 331, which is a region in which the active material is not applied.

A first electrode active portion of the first electrode 310 may have an active material such as a transition metal oxide applied to a metal foil such as aluminum, and a second electrode active portion of the second electrode 330 may have an active material such as graphite or carbon applied to a metal foil such as copper or nickel.

The separator 350 of the electrode assembly 300 is positioned between the first electrode 310 and the second electrode 330, more specifically between the first electrode active portion and the second electrode active portion, to prevent or suppress a short circuit therebetween and to allow migration of ions. For example, the separator 350 may be formed of various materials such as polyethylene, polypropylene, or a composite film thereof.

The first electrode tab 311 may protrude from one side of the first electrode active portion, and the second electrode tab 331 may protrude from one side of the second electrode active portion. At this time, the first electrode tab 311 and the second electrode tab 331 may protrude in opposite directions toward respective cap assemblies 701 and 703. However, the present disclosure is not limited thereto, and when the case 100 has a shape in which only one surface is open, the first electrode tab 311 and the second electrode tab 331 may protrude toward the same cap assembly 700 (see, e.g., FIG. 16).

Since the first electrode tab 311 and the second electrode tab 331 of the electrode assembly 300 are formed by cutting the metal foil so as to protrude from the metal foils of the first electrode active portion and the second electrode active portion, the first electrode tab 311 and the second electrode tab 331 may be integrally formed with the metal foils of the first electrode active portion and the second electrode active portion, respectively.

Each of the first electrode tabs 311 and the second electrode tab 331 of the electrode assembly 300 may be formed by overlapping a plurality of thin films, and the thin films may be connected to each other so as to be in contact by, for example, ultrasonic welding or laser welding to facilitate current flow.

A plurality of first electrode tabs 311 may be provided, and the plurality of first electrode tabs 311 may form different rows. The plurality of first electrode tabs 311 disposed in different rows may be formed at different positions in, for example, a height direction (e.g., the z direction) and a width direction (e.g., the y direction). Although not illustrated, the second electrode tabs 331 may also form different rows in the same manner as the first electrode tabs 311. However, the disclosure is not limited thereto, and the first electrode tabs 311 and the second electrode tabs 331 may each be formed in a single row.

The first electrode tabs 311 of the electrode assembly 300 may be coupled to a first current-collecting plate 510, and the second electrode tabs 331 may be coupled to a second current-collecting plate 530. The electrode tabs 311 and 331 may be coupled to the respective current-collecting plates 510 and 530 by welding. At this time, for example, ultrasonic welding or laser welding may be applied as the welding method.

The electrode tabs 311 and 331 of the electrode assembly 300 may be coupled to the respective current-collecting plates 510 and 530. For example, the electrode tabs 311 and 331 may be coupled, in a bent state, to outer surfaces of the current-collecting plates 510 and 530, or may be coupled to inner surfaces thereof.

The current-collecting plates 510 and 530 of the secondary battery 10 are plate-shaped members formed of a conductive material, and may be coupled to the respective electrode tabs 311 and 331 to be electrically connected to the respective electrodes 310 and 330.

The first current-collecting plate 510 of the secondary battery 10 may be connected to a first electrode terminal 710 exposed to the outside of the first cap assembly 701. The first current-collecting plate 510 may be directly connected to the first electrode terminal 710, or alternatively, may be connected to the first electrode terminal 710 via a first connection terminal 511.

The first connection terminal 511 of the first current-collecting plate 510 may be formed on an outer surface of the first current-collecting plate 510 facing the first cap assembly 701. The first connection terminal 511 may be positioned approximately at the center of the first current-collecting plate 510; however, the present disclosure is not limited thereto, and the first connection terminal 511 may be positioned offset toward one side on the first current-collecting plate 510. The first connection terminal 511 may be integrally formed with the first current-collecting plate 510 in a columnar shape, or may be coupled to the first current-collecting plate 510. The first connection terminal 511 may be inserted into a first terminal hole 711 to electrically connect the first current-collecting plate 510 and the first electrode terminal 710. When the first current-collecting plate 510 and the first electrode terminal 710 are electrically connected, the first electrode 310 of the secondary battery 10 and the first electrode terminal 710 may be electrically connected.

The second current-collecting plate 530 of the secondary battery 10 may be connected to a second electrode terminal 730 exposed to the outside of the second cap assembly 703. However, when the case 100 has a shape in which only one surface is open, the first current-collecting plate 510 and the second current-collecting plate 530 may be connected to the first electrode terminal 710 and the second electrode terminal 730, respectively, which are located on the same cap assembly 700 (see, e.g., FIG. 16).

The second current-collecting plate 530 of the secondary battery 10 may also be connected to the second electrode terminal 730 via a second connection terminal 531. When the second current-collecting plate 530 and the second electrode terminal 730 are electrically connected, the second electrode 330 and the second electrode terminal 730 may be electrically connected. Since the other structures of the second current-collecting plate 530 are substantially similar to those of the first current-collecting plate 510, redundant descriptions of the repeated structures will be omitted.

The cap assembly 700 may seal an opening of the case 100 in which the electrode assembly 300 is accommodated. In the present embodiment, a structure in which opposite side surfaces of the case 100 are open and a plurality of cap assemblies 701 and 703 respectively seal the openings, as illustrated in FIG. 2, is described as an example; however, the disclosure is not limited thereto, and for example, as illustrated in FIG. 16, the case 100 may have only one surface open, and accordingly, only one cap assembly 700 may be provided. However, in any case, the cap assembly 700 is positioned on a surface different from the lower surface 101 of the case 100 on which the spacing member 130 is formed.

Referring to FIG. 2, the first cap assembly 701 of the secondary battery 10 may have a plate-like shape that covers one side surface of the case 100 in a length direction (e.g., the x direction). The first cap assembly 701 may have a shape corresponding to that of an opening of the case 100. The first cap assembly 701 may be formed of the same material as the case 100, and for example, the first cap assembly 701 may be fixed to the case 100 by laser welding.

The first cap assembly 701 may include a first electrode terminal 710 exposed to the outside. A first terminal hole 711 into which the first connection terminal 511 of the first current-collecting plate 510 is inserted, and an electrolyte injection port 770 for injecting an electrolyte, may be formed in the first cap assembly 701.

The first electrode terminal 710 of the first cap assembly 701 may protrude outward from the first cap assembly 701. The first electrode terminal 710 may be electrically connected to the first electrode 310 of the electrode assembly 300 through the first current-collecting plate 510. The first electrode terminal 710 of the first cap assembly 701 may be formed in a plate-like shape having a circular or rectangular shape. Such a first electrode terminal 710 may be connected to, for example, a busbar.

A first insulating member (not illustrated) may be disposed between the first electrode terminal 710 of the first cap assembly 701 and the first cap assembly 701 so as to electrically insulate the first electrode terminal 710 from the first cap assembly 701.

The second cap assembly 703 of the secondary battery 10 is disposed to face the first cap assembly 701, and may seal the other side surface of the case 100 in the length direction (e.g., the x direction). The second cap assembly 703 may also have a second electrode terminal 730 exposed to the outside. The second cap assembly 703 may include a second terminal hole 731 into which a second connection terminal 531 of the second current-collecting plate 530 is inserted, and an electrolyte injection port 770 through which an electrolyte is injected. Since other structures of the second cap assembly 703 are substantially similar to those of the first cap assembly 701, redundant descriptions thereof will be omitted.

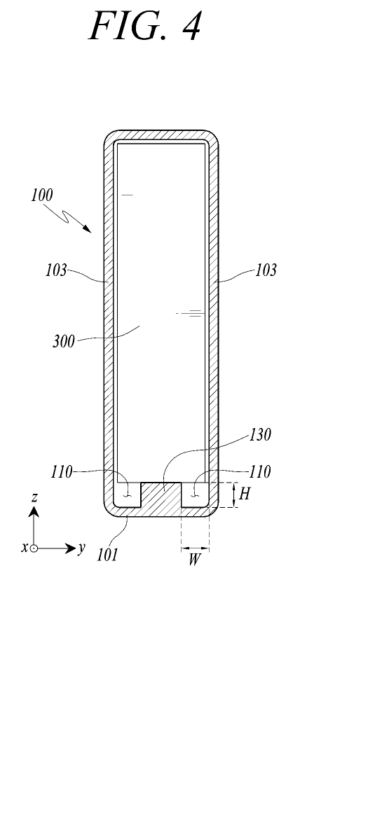

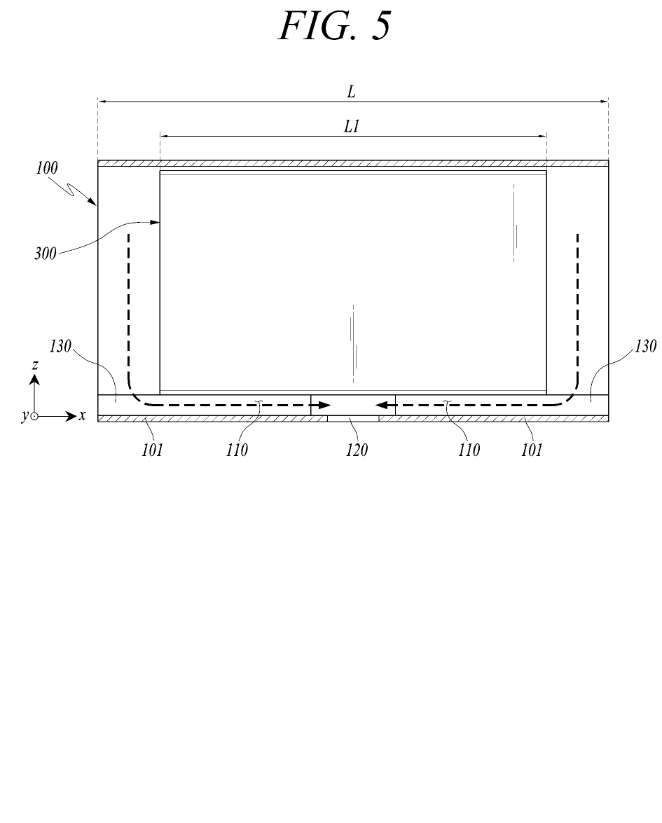

FIG. 3 is a projection perspective view illustrating an interior of a case 100 of the secondary battery 10, FIG. 4 is a side view of the case 100 of FIG. 3, in which the electrode assembly 300 is accommodated, as viewed in a length direction, and FIG. 5 is a cross-sectional view illustrating the case 100 of FIG. 3, in which the electrode assembly 300 is accommodated, taken along line A-A.

Referring to FIG. 3, a spacing member 130, a vent hole 120, and a venting flow path 110, according to an embodiment of the present disclosure, are formed in the lower surface 101 of the case 100. Since the electrode assembly 300 is spaced apart from the vent hole 120 by the spacing member 130, a space through which gas inside the case 100 moves toward the vent hole 120 may be secured. The gas inside the case 100 may be guided by the spacing member 130 along the venting flow path 110 and discharged to the outside through the vent hole 120.

The spacing member 130, according to an embodiment of the present disclosure, protrudes from the lower surface 101 of the case 100 toward an inner space of the case 100. According to an embodiment, the spacing member 130 may be formed of the same material as the case 100. The spacing member 130 may be integrally formed with the case 100, and the case 100 and the spacing member 130 may be manufactured by an extrusion process. However, the manufacturing method of the spacing member 130 is not limited thereto, and the spacing member 130 may be separately manufactured and then coupled to the lower surface 101 of the case 100.

The spacing member 130 formed on the lower surface 101 of the case 100 may extend along the length direction (e.g., the x direction) of the lower surface 101 of the case 100. For example, the spacing member 130 may extend from an arbitrary point of the lower surface 101 to one end in the length direction (e.g., the x direction).

A plurality of spacing members 130 may be formed. The plurality of spacing members 130 may be disposed to be spaced apart from each other. The plurality of spacing members 130 may be spaced apart from each other in the length direction (e.g., the x direction).

The plurality of spacing members 130 may extend such that one ends thereof face each other with a gap therebetween, and opposite ends thereof are respectively positioned at ends of the lower surface 101. As such, the plurality of spacing members 130 spaced apart in the length direction (e.g., the x direction) may be positioned in the same row. For example, the plurality of spacing members 130 spaced apart in the length direction (e.g., the x direction) may form a single row with gaps therebetween.

The plurality of spacing members 130 may be disposed at the center of the lower surface 101 in the width direction (e.g., the y direction). The plurality of spacing members 130 may be spaced apart from each other in the length direction (e.g., the x direction) at the center of the lower surface 101 in the width direction (e.g., the y direction) to form a single row. However, the present disclosure is not limited to the above arrangement, and for example, the plurality of spacing members 130 may form a single row while being disposed offset toward one side in the width direction (e.g., the y direction) of the lower surface 101.

According to an embodiment of the present disclosure, the vent hole 120 may be positioned between the plurality of spacing members 130 formed on the lower surface 101 of the case 100. The vent hole 120 may be an openable/closable member and may include a notch. When the internal pressure of the case 100 exceeds a reference pressure, the notch of the vent hole 120 may be ruptured to discharge gas inside the case 100 to the outside.

According to an embodiment, the vent hole 120 may be positioned between a pair of spacing members 130 spaced apart from each other in the length direction (e.g., the x direction). For example, the vent hole 120 may be positioned at the center of the lower surface 101 of the case 100 in a width direction (y direction), and may be positioned in the same row as the spacing members 130. However, the position of the vent hole 120 is not limited thereto, and may be changed within a range that may be adopted by those ordinarily skilled in the related art, such as being positioned in a row different from that of the spacing members 130 or being disposed offset toward one side in the width direction (e.g., the y direction) of the lower surface 101.

According to an embodiment of the present disclosure, a venting flow path 110 is disposed on a side of the spacing members 130 on the lower surface 101. The venting flow path 110 is a space defined by the spacing members 130 protruding from the lower surface 101 of the case 100 in the height direction (e.g., the z direction), and provides a space through which gas inside the case 100 moves. For example, the gas moving along the venting flow path 110 may be guided by the spacing members 130 and discharged through the vent hole 120.

Since the spacing member 130 has a shape protruding from the lower surface 101, the venting flow path 110 has a shape that is relatively recessed from the upper surface of the spacing member 130. The venting flow path 110 has a shape extending along the spacing members 130 in the length direction (e.g., the x direction), and the depth of the venting flow path 110 is the same as the height H of the spacing member 130.

In this embodiment, the venting flow path 110 may be positioned at opposite ends of the lower surface 101 in the width direction (e.g., the y direction). A plurality of venting flow paths 110 may converge at the central portion of the lower surface 101 in which the vent hole 120 is positioned.

Referring to FIG. 4, the venting flow paths 110 positioned in the width direction (e.g., the y direction) of the lower surface 101 may have a vertical cross section. For example, the side surfaces of the spacing member 130, the lower surface 101 of the case 100, and the side surfaces 103 of the case 100 may be perpendicular to each other. However, the present disclosure is not limited thereto, and for example, the venting flow paths 110 may have a smooth U-shaped cross section to prevent formation of turbulence and thus prevent or suppress gas stagnation, or may have a V-shaped cross section having inclined side surfaces to accelerate gas flow.

Meanwhile, the width W of the venting flow path 110 may be constant along the length direction (e.g., the x direction) and the height direction (e.g., the z direction). For example, the width W of the venting flow path 110 may range from about 3 mm to about 12 mm. According to an embodiment, the width W of the venting flow path 110 may range from about 5 mm to about 10 mm.

The depth of the venting flow path 110, for example, the height H of the spacing member 130, may range from about 0.1 mm to about 1.0 mm. According to an embodiment, the height H of the spacing member 130 may range from about 0.2 mm to about 0.5 mm, or may be about 0.3 mm.

Referring to FIG. 5, the electrode assembly 300 may be accommodated inside the case 100 and disposed on the spacing members 130. The plurality of spacing members 130 may support the electrode assembly 300, and at the same time, may space the electrode assembly 300 apart from the vent hole 120.

The length L1 of the electrode assembly 300 may be shorter than the length L of the case 100. Accordingly, the upper portions of the venting flow paths 110 may be exposed to the inner space of the case 100 in some regions in the length direction (e.g., the x direction).

With the structure described above, the gas inside the case 100 may flow into the venting flow paths 110 through the inner space around the electrode assembly 300. The gas flowing into the venting flow path 110 may move along the space between the electrode assembly 300 and the lower surface 101 of the case 100, for example, along the venting flow paths 110. The gas may be guided by the spacing members 130 and move to the vent hole 120, and may be exhausted to the outside through the vent hole 120.

According to the embodiment, since the electrode assembly 300 is spaced apart from the vent hole 120 by the spacing members 130, a space through which the gas inside the case 100 moves toward the vent hole 120 may be secured. For example, the vent hole 120 formed in the lower surface 101 of the case 100 is not blocked by the electrode assembly 300. As a result, the gas inside the case 100 may be rapidly discharged to the outside of the case 100 along the venting flow paths 110 and the vent hole 120, thereby preventing or suppressing an explosion of the secondary battery 10 and improving safety.

Hereinafter, a secondary battery, according to a second embodiment of the present disclosure, will be described.

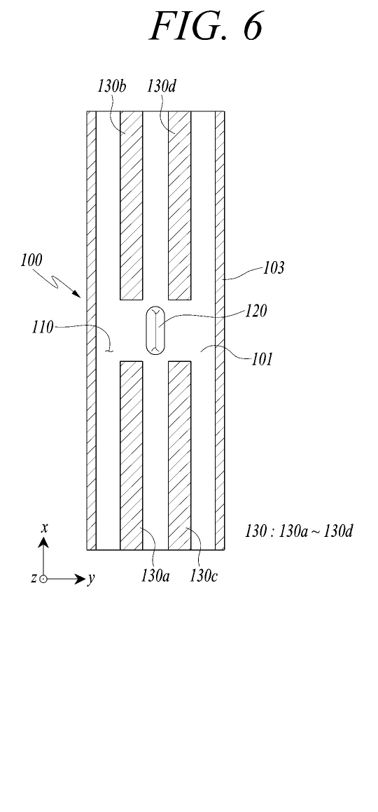

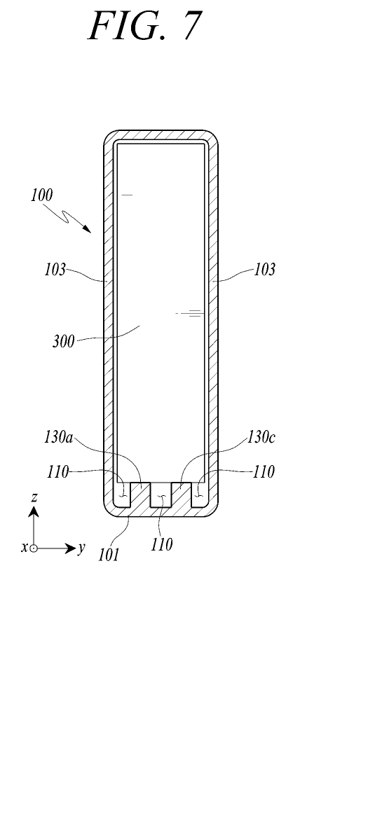

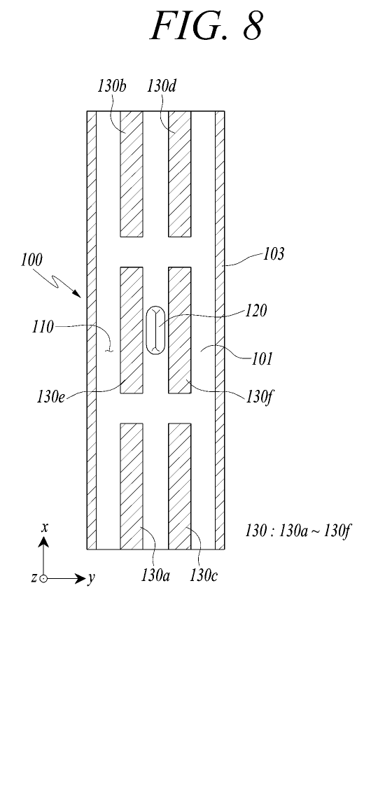

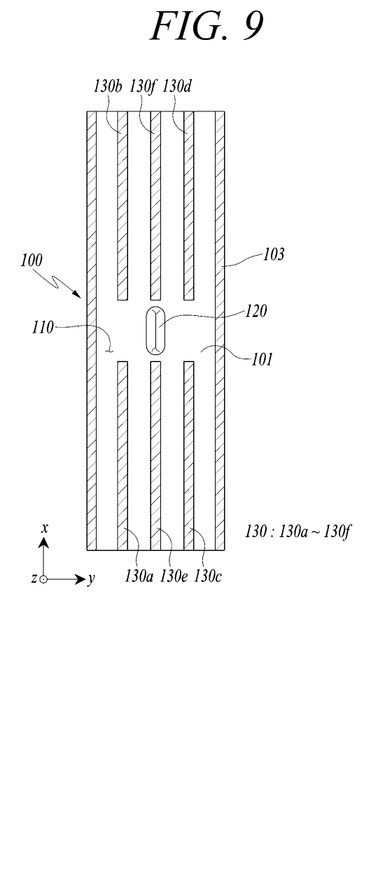

FIG. 6 is a horizontal cross-sectional view illustrating a lower surface of a case 100 of a secondary battery 10, according to a second embodiment of the present disclosure, and FIG. 7 is a vertical cross-sectional side view of the case of FIG. 6. FIG. 8 illustrates a modified example of the case of FIG. 6, and FIG. 9 illustrates another modified example of the case of FIG. 6.

The secondary battery, according to the second embodiment of the present disclosure, has a structure substantially similar to that of the first embodiment except for an arrangement of a spacing member 130, and thus, redundant descriptions of repeated components will be omitted.

As illustrated in FIGS. 6 and 7, a plurality of spacing members 130 may be spaced apart from each other in the width direction (e.g., the y direction). The plurality of spacing members 130 may form a plurality of rows in the width direction (e.g., the y direction).

For example, one pair of spacing members 130a and 130c may be spaced apart from each other in the width direction (e.g., the y direction), and another pair of spacing members 130b and 130d may also be spaced apart from each other in the width direction (e.g., the y direction).

In addition, the one pair of spacing members 130a and 130c and the other pair of spacing members 130b and 130d may be spaced apart from each other in the length direction (e.g., the x direction).

In this case, the spacing members 130a and 130b on one side may be arranged in a single row, and spacing members 130c and 130d on the other side may also be arranged in a single row, such that the plurality of spacing members 130 may form two rows spaced apart from each other in the width direction (e.g., the y direction).

However, one row is not necessarily formed by two spacing members 130a and 130b , and a single row may be formed by three spacing members 130a, 130b, and 130e or by a greater number of spacing members (see, e.g., FIG. 8). In addition, the plurality of rows are not limited to two, and may include three or more rows (see, e.g., FIG. 9).

Meanwhile, the vent hole 120 may be positioned between a pair of rows formed by the plurality of spacing members 130. For example, the vent hole 120 may be connected to the venting flow paths 110 in the width direction (e.g., the y direction) and the length direction (e.g., the x direction) between the pair of rows.

Since a gap is formed between the spacing members 130a and 130b and between the spacing members 130c and 130d that are spaced apart from each other in the length direction (e.g., the x direction), the plurality of venting flow paths 110 may be connected to each other in the width direction (e.g., the y direction). In this case, the vent hole 120 may be positioned at a point at which the plurality of venting flow paths 110 are connected, so as to discharge gas moving along all of the venting flow paths 110 to the outside of the case 100.

According to the structure described above, even when the number of venting flow paths 110 increases as the spacing members 130 form a plurality of rows, the gas moving along all of the venting flow paths 110 may be smoothly discharged through the vent hole 120.

According to the structure of the embodiment, the electrode assembly 300 is supported by the spacing members 130 formed in the plurality of rows, thereby improving stability, and thus, the electrode assembly 300 may be accommodated more safely without tilting inside the case 100 even under vibration in the width direction (e.g., the y direction).

In addition, the gas distributed around the electrode assembly 300 inside the case 100 may flow into a nearby venting flow path 110 and be smoothly and rapidly discharged through the vent hole 120, thereby preventing or suppressing the risk of explosion of the secondary battery 10 and further improving safety.

Hereinafter, a secondary battery, according to a third embodiment of the present disclosure, will be described.

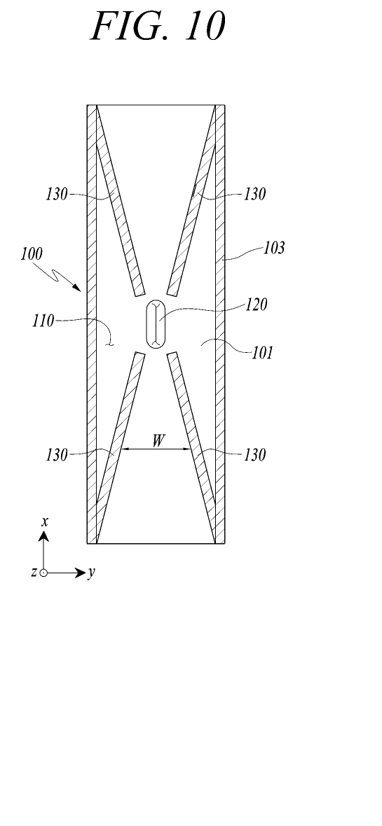

FIG. 10 is a horizontal cross-sectional view illustrating a lower surface of a case of a secondary battery, according to the third embodiment of the present disclosure.

The secondary battery 10, according to the third embodiment of the present disclosure, has a structure substantially similar to that of the secondary battery 10, according to the second embodiment, except for structures of a spacing member 130 and a venting flow path 110, and thus, redundant descriptions of repeated components will be omitted.

As illustrated in FIG. 10, a plurality of spacing members 130 may be spaced apart from each other to form an X-shaped arrangement.

For example, the plurality of spacing members 130 may be arranged in an X-shape on the lower surface 101 of the case 100. The plurality of spacing members 130 may each be positioned at corners of the lower surface 101. A vent hole 120 may be positioned at the center of the lower surface 101, and end portions of the plurality of spacing members 130 may face the vent hole 120.

The venting flow paths 110 may be positioned between adjacent pairs of spacing members 130. Since the distance between each adjacent pair of spacing members 130 decreases as the spacing members approach the vent hole 120, a width W of the venting flow paths 110 in this embodiment may decrease toward the vent hole 120. For example, the gas moving along the venting flow paths 110 may be gathered toward the vent hole 120. As a result, the gas may be accelerated toward the vent hole 120 and rapidly discharged to the outside of the case 100.

According to the structure described above, since the spacing members 130 are arranged to intersect the lower surface 101 in diagonal directions, the electrode assembly 300 (see, e.g., FIG. 7) disposed on the spacing members 130 may be stably supported in both the width direction (e.g., the y direction) and the length direction (e.g., the x direction). As a result, the electrode assembly 300 (see, e.g., FIG. 7) may be stably accommodated inside the case 100 even under vibrations in multiple directions, thereby improving stability of the secondary battery 10.

In addition, according to the above structure, since the venting flow paths 110 are formed over an entire area of the lower surface 101, the gas distributed at various positions inside the case 100 may be rapidly discharged, thereby preventing or suppressing an explosion of the secondary battery 10 and further improving safety.

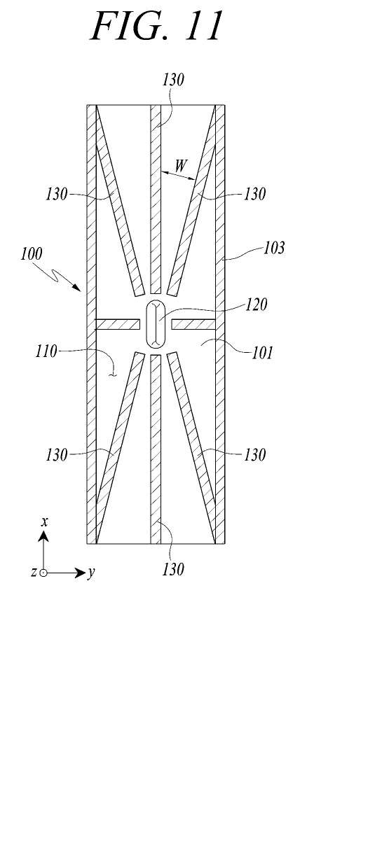

FIG. 11 illustrates a modified example of the case of FIG. 10.

Referring to FIG. 11, the plurality of spacing members 130 may be radially arranged. Except for this arrangement, similarly to FIG. 10, the vent hole 120 is positioned at the center of the lower surface 101, and end portions of the plurality of spacing members 130 may face the vent hole 120.

According to the above structure, since an area over which the spacing members 130 support the electrode assembly 300 (see, e.g., FIG. 7) is relatively increased, the electrode assembly 300 (see, e.g., FIG. 7) may be supported more stably, thereby further improving stability of the secondary battery 10.

Hereinafter, a secondary battery 10 according to a fourth embodiment of the present disclosure will be described.

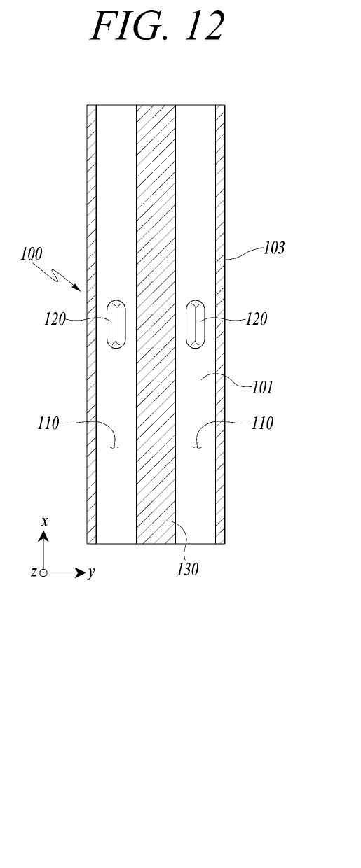

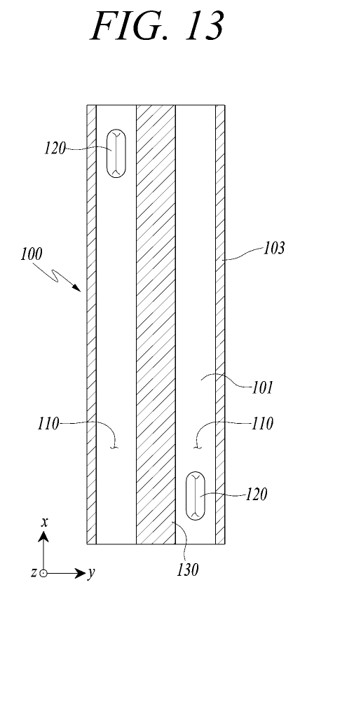

FIG. 12 is a horizontal cross-sectional view illustrating a lower surface of a case 100 of the secondary battery 10, according to the fourth embodiment of the present disclosure, and FIG. 13 illustrates a modified example of the case 100 of FIG. 12.

The secondary battery 10, according to the fourth embodiment of the present disclosure, has a structure substantially similar to that of the secondary battery 10, according to the first embodiment, except for a spacing member 130, a venting flow path 110, and a vent hole 120, and thus, redundant descriptions of repeated components will be omitted.

As illustrated in FIGS. 12 and 13, the spacing member 130 may extend from one end to the other end of the lower surface 101 in the length direction (e.g., the x direction). For example, in this embodiment, rather than having a plurality of spacing members 130 spaced apart from each other in the length direction (x direction), a single spacing member 130 may extend across the lower surface 101 from one end to the other end.

The spacing member 130 may be positioned at a center of the lower surface 101 in the width direction (e.g., the y direction). The venting flow paths 110 may be positioned on opposite sides of the spacing member 130 in the width direction (e.g., the y direction), and each of the venting flow paths 110 may extend along the length direction (e.g., the x direction).

The plurality of venting flow paths 110 may be formed to be spaced apart from each other in the width direction (e.g., the y direction) and arranged in parallel. For example, the plurality of venting flow paths 110 may be parallel to each other without merging.

Although two venting flow paths 110 are illustrated in FIG. 12, the present disclosure is not limited thereto, and three or more venting flow paths 110 may be formed to be spaced apart from each other in the width direction (e.g., the y direction) and arranged in parallel.

In this embodiment, a plurality of vent holes 120 may be formed. The plurality of vent holes 120 may be positioned in respective venting flow paths 110. All of the plurality of vent holes 120 may be positioned at centers of the respective venting flow paths 110 in the length direction (e.g., the x direction).

Referring to FIG. 13, the plurality of vent holes 120 may be alternately positioned at one side and the other side of the respective venting flow paths 110 in the length direction (e.g., the x direction). For example, one vent hole 120 may be positioned offset toward one side in the length direction (e.g., the x direction) of one venting flow path 110, and another vent hole 120 may be positioned offset toward the other side in the length direction (e.g., the x direction) of another venting flow path 110.

According to the embodiment, since the spacing member 130 extends along the lower surface 101 of the case 100 from one end to the other end, an area for supporting the electrode assembly 300 (see, e.g., FIG. 7) is increased, thereby improving stability.

In addition, according to the embodiment, gas inside the case 100 may be rapidly discharged through a nearest one of the plurality of vent holes 120, thereby preventing or suppressing a risk of an explosion of the secondary battery 10 and further improving the safety.

Hereinafter, a secondary battery, according to a fifth embodiment of the present disclosure, will be described.

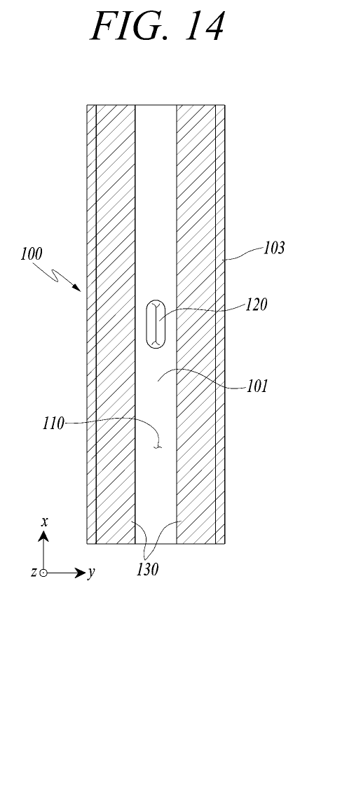

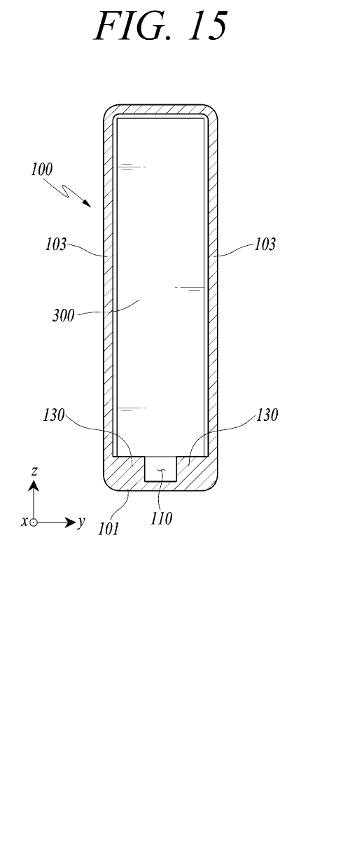

FIG. 14 is a horizontal cross-sectional view illustrating a lower surface of a case 100 of a secondary battery 10, according to the fifth embodiment of the present disclosure, and FIG. 15 is a vertical cross-sectional side view of the case of FIG. 14.

The secondary battery 10, according to the fifth embodiment of the present disclosure, has a structure substantially similar to that of the secondary battery 10, according to the fourth embodiment, except for a spacing member 130, a venting flow path 110, and a vent hole 120, and thus, redundant descriptions of repeated components will be omitted.

Referring to FIG. 14, a plurality of spacing members 130 may be formed and disposed at opposite ends of the lower surface 101 in the width direction (e.g., the y direction). In this case, similarly to the fourth embodiment, each of the spacing members 130 may extend from one end to the other end of the lower surface 101.

The venting flow path 110 may be positioned between a pair of spacing members 130 spaced apart from each other in the width direction (e.g., the y direction). For example, in this embodiment, the venting flow path 110 may be positioned at the center of the lower surface 101 in the width direction (e.g., the y direction) and may be defined by the pair of spacing members 130.

A vent hole 120 may be positioned in the venting flow path 110, and for example, may be positioned at the center of the venting flow path 110 in the length direction (e.g., the x direction).

Referring to FIG. 15, in contrast to FIG. 5 in which the spacing members 130 protrude from the center of the flat lower surface 101, the case 100, according to the embodiment, may have a shape in which the venting flow path 110 is recessed at the center of the lower surface 101.

As a result, an area in which the electrode assembly 300 contacts the spacing members 130 is increased, thereby improving stability, and for example, the electrode assembly 300 may be stably accommodated inside the case 100 even under vibrations in the width direction (e.g., the y direction).

Hereinafter, a secondary battery 10 according to a sixth embodiment of the present disclosure will be described.

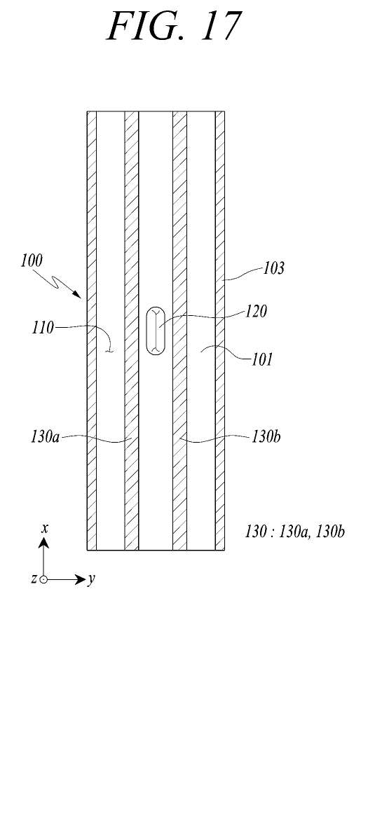

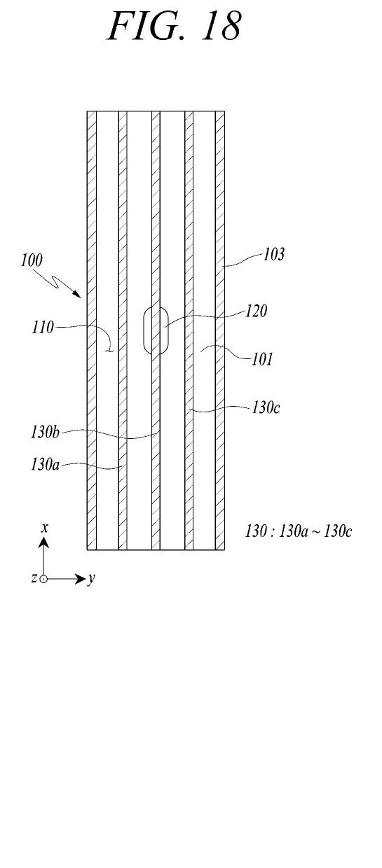

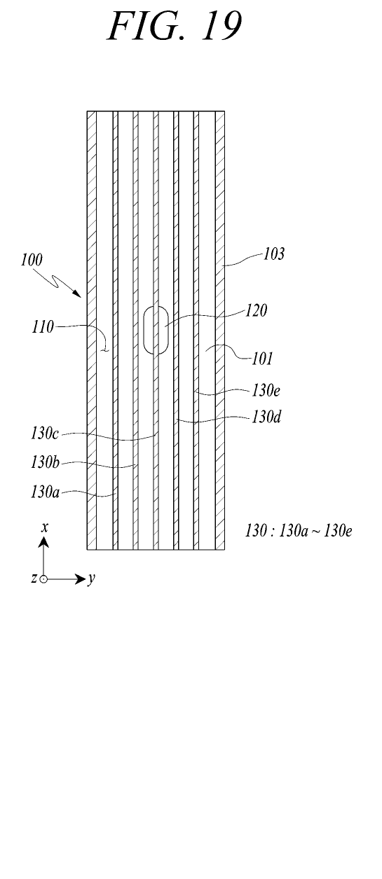

FIG. 17 is a horizontal cross-sectional view illustrating a lower surface of a case 100 of a secondary battery 10, according to a sixth embodiment of the present disclosure, FIG. 18 illustrates a modified example of the case of FIG. 17, and FIG. 19 illustrates another modified example of the case of FIG. 17.

The secondary battery 10, according to the sixth embodiment of the present disclosure, has a structure substantially similar to that of the secondary battery 10, according to the second or fourth embodiment, except for a spacing member 130, and a vent hole 120, and thus, redundant descriptions of repeated components will be omitted.

As illustrated in FIG. 17, the plurality of the spacing member 130 may extend from one end to the other end of the lower surface 101 in the length direction (e.g., the x direction). The plurality of the spacing member 130 may form a plurality of rows extending from one end to the other end of the lower surface 101. The plurality of the spacing member 130 may be spaced apart from each other in the width direction (e.g., the y direction).

The plurality of the spacing member 130 may form a plurality of rows arranged parallel to each other. For example, the spacing members 130a and 130b may form two rows arranged parallel to each other, as illustrated in FIG. 17. Alternatively, the spacing members 130a to 130c may form three rows arranged parallel to each other, as illustrated in FIG. 18, or the spacing members 130ato 130e may form five rows arranged parallel to each other, as illustrated in FIG. 19.

The vent hole 120 may be positioned between an adjacent pair of the rows. However, the present disclosure is not necessarily limited thereto, and the vent hole 120 may overlap with at least one of the plurality of the spacing member 130 in the height direction (e.g., the z direction).

According to the embodiment, since the spacing member 130 extends along the lower surface 101 of the case 100 from one end to the other end, an area for supporting the electrode assembly 300 (see, e.g., FIG. 7) is increased, thereby improving stability.

While the embodiments of the present disclosure have been described, it will be appreciated by one of ordinary skill or knowledge in the art that the embodiments of the present disclosure may be changed or modified in various ways within the scope that does not depart from the technical scope of the various embodiments of the present disclosure defined in the claims attached herein below.

What is claimed is:

1. A secondary battery comprising:
a case;
an electrode assembly accommodated in the case;
a vent hole formed in a lower surface of the case;
a spacing member protruding from the lower surface of the case and configured to space the electrode assembly apart from the vent hole;
a venting flow path disposed on a side of the spacing member on the lower surface; and
a cap assembly configured to seal the case,
wherein gas inside the case is guided by the spacing member along the venting flow path and discharged to an outside through the vent hole.

2. The secondary battery according to claim 1, wherein the spacing member is integrally formed with the case.

3. The secondary battery according to claim 1, wherein the spacing member extends along a length direction of the lower surface.

4. The secondary battery according to claim 3, wherein a plurality of the spacing members are provided to be spaced apart from each other.

5. The secondary battery according to claim 4, wherein the plurality of the spacing members are spaced apart from each other along the length direction.

6. The secondary battery according to claim 5, wherein the plurality of the spacing members are positioned in the same row.

7. The secondary battery according to claim 5, wherein the vent hole is positioned between the plurality of the spacing members.

8. The secondary battery according to claim 4, wherein the plurality of the spacing members form a plurality of rows spaced apart from each other in a width direction.

9. The secondary battery according to claim 4, wherein the plurality of the spacing members are arranged in an X-shape.

10. The secondary battery according to claim 3, wherein the spacing member extends from one end to the other end of the lower surface in the length direction.

11. The secondary battery according to claim 10, wherein the spacing member is positioned at a center of the lower surface in a width direction.

12. The secondary battery according to claim 10, wherein a plurality of the vent holes is formed.

13. The secondary battery according to claim 10, wherein a plurality of the spacing members are formed, and the plurality of the spacing members are positioned at opposite ends of the lower surface in a width direction.

14. The secondary battery according to claim 1, wherein the spacing member is formed of the same material as the case.

15. The secondary battery according to claim 14, wherein the case and the spacing member are manufactured by an extrusion method.

16. The secondary battery according to claim 10, wherein a plurality of the spacing members are formed, and the plurality of the spacing members form a plurality of rows extending from one end to the other end of the lower surface.

17. The secondary battery according to claim 16, wherein the plurality of the spacing members form three rows arranged parallel to each other.

18. The secondary battery according to claim 16, wherein the plurality of the spacing members form five rows arranged parallel to each other.

19. The secondary battery according to claim 16, wherein the vent hole is positioned between an adjacent pair of rows.

20. The secondary battery according to claim 16, wherein the vent hole overlap with at least one of the plurality of the spacing members in a height direction.
